(19) United States
(12) Patent Application Publication
(10) Pub. No.: US 2010/0307055 A1
(43) Pub. Date: Dec. 9, 2010

(54) PROTECTION OF PLASTICS

(76) Inventors: Jack Silver, Middlesex (GB); Robert Withnall, Middlesex (GB)

Correspondence Address: Intellectual Property Dept.;Dewitt Ross & Stevens SC, 2 East Mifflin Street, Suite 600, Madison, WI, 53703-2865, US

(21) Appl. No.: 12/739,043

(22) PCT Filed: Oct. 22, 2008
(86) PCT No.: PCT/GB2008/003584

§ 371 Date: Jul. 20, 2010

(30) Foreign Application Priority Data
Oct. 23, 2007 (GB) 0720717.8

(51) Int. Cl. A01G 9/14; F21V 9/06

(52) U.S. Cl. 47/17; 252/589

(57) ABSTRACT

There are disclosed plastics materials (110; 520; 640) that include one or more phosphors (210) for absorbing ultraviolet (UV) light (170, 420) and re-radiating (160, 410) the light at a longer wavelength, for example the red wavelengths at 680 nm and 700 nm used by a plant (130) for photosynthesis. Such plastics materials may be used to protect the plastic (110, 500) from UV-induced degradation. In another embodiment, a light source (600) is provided with an encapsulant (640) that contains a phosphor (210) to prevent UV-light from escaping from the light source. Examples of the phosphor (210) are iron activated lithium aluminate phosphor although the phosphor may be based on lattices comprising, for example, aluminates, silicates, aluminosilicates, phosphates or borates or mixtures thereof. The phosphors may include activators/co-activators/sensitizers based on transition metals or lanthanides.

The present invention is generally, though not exclusively, concerned with protection of plastics from UV (ultraviolet) light.

A variety of different types (e.g. polyethylene, polycarbonate, polystyrene, polyvinylchloride) are well known. When plastics are used outside and are exposed to sunlight, they typically suffer gradual deterioration due to UV induced damage. Plastics are typically provided with fillers such as dyes or phosphors in order to reduce the UV induced damage. A known phosphor is zinc sulphide (ZnS). ZnS may be used to provide phosphorescent (“glow in the dark”) plastics, these typically glow with a green colour. A disadvantage of ZnS is that the sulphur tends to react with plastics, causing degradation of a plastic. Another problem with ZnS is that it tends to absorb moisture and this also can lead to degradation of a plastic.

U.S. Pat. No. 6,207,077 discloses luminescent gel coats and mouldable resins. U.S. Pat. No. 6,207,077 discloses compositions that as well as including phosphors, also include UV stabilisers to protect the gel coat polymer, and further discloses the use of UV absorbers, UV quenchers, and UV scavengers and quenchers.

“STRAWBERRY AND CUCUMBER CULTIVATION UNDER FLUORESCENT PHOTOSELECTIVE PLASTIC FILMS COVER”; by A. Gonzalez, R. Rodriguez, S. Bañón, J. A. Franco, J. A. Fernández, A. Salmerón, E. Espí; in ISHS Acta Horticulturae 614: VI International Symposium on Protected Cultivation in Mild Winter Climate Product and Process Innovation; discloses an evaluation of the efficiency of fluorescent plastic films, especially those including additives that work as green to red light converters. Two field tests were carried out in Spanish sites using a strawberry crop under a low tunnel and a cucumber crop under a Kyoto type tunnel-greenhouse. The film' evolution of light properties, the strawberry and cucumber yields and the population size of western flower thrips (Frankliniella occidentalis) were determined. The following films were tested: UV-absorbing fluorescent orange coextruded three layer and fluorescent magenta coextruded three layer. An UV-nonabsorbing white coextruded three layer film was used as film control. All the compared films were 75μ thick. Measurement of light properties throughout crop production had the greatest PAR and UV transmission by the white coextruded three layer film (control). The yields and growth and development characteristics of strawberry and cucumber plants were quite irregular and were independent of the plastic film used. The maximum population of thrips were observed in the tunnel-greenhouses covered with control film. On the contrary, the minimum population of thrips was observed in UV-absorbing fluorescent magenta coextruded three layer film.

The present invention seeks to provide improved plastics.

According to a first aspect of the invention, there is provided a plastic comprising a phosphor.

Advantageously, the phosphor protects the plastic by absorbing UV light and downconverting (i.e. the phosphor fluoresces: converts a shorter wavelength of light to a longer wavelength) the incident light to longer wavelength that is less destructive to the plastic.

According to a second aspect of the invention, there is provided a plastic comprising a phosphor,
wherein the plastic has a first wavelength at which the plastic substantially absorbs ultraviolet light,
wherein the phosphor has a second wavelength at which the phosphor is substantially non-phosphorescent, and
wherein the first and second wavelengths are separated by no more than a predetermined wavelength from each other.

Advantageously, a plastic according to the second aspect has substantially the same wavelength-dependent optical transmission as untreated plastic but at UV wavelengths, instead of the UV being absorbed by the plastic with resultant damage to the plastic, the UV is substantially absorbed by the phosphor and downconverted to a longer wavelength. For example, polycarbonate has is substantially transparent (that is, excluding absorption in the infra-red region) to light having a wavelength longer than about 275 nm but strongly absorbs light having a wavelength less than about 275 nm.

According to a third aspect of the invention, there is provided a plastic comprising a phosphor, wherein the phosphor is suitable for downconverting incident light to a wavelength suitable for a biological process.

Advantageously, a plastic according to the third aspect may be used to downconvert light, for example UV that would otherwise damage the plastic, to either of the 680 nm (photosystem I) and 700 m (photosystem II) wavelength regions at which plant chlorophyll absorbs light for photosynthesis.

According to a fourth aspect of the invention, there is provided a plastic comprising first and second layers, wherein the second layer comprises a phosphor.

Advantageously, the second layer protects the first layer from UV. For example, the bulk of an item such as a glazing panel for a window may be formed from a UV sensitive plastic and the second layer is arranged to face towards a UV source (such as the sun) so that the second layer protects the first layer from UV induced damage or degradation.

### DESCRIPTION OF FIGURES

FIG. 1 shows a schematic view of a polytunnel comprising a plastic sheet covering a plant, according to some embodiments of the present invention.

FIG. 2 shows a cross-sectional view of a portion of the plastic sheet of FIG. 1.

FIG. 3 shows a diagram of light absorption versus wavelength for a plastic and a UV phosphor.

FIG. 4 shows the affect of the UV phosphor of FIG. 2 on intensity of the light spectrum that is received by the plant of FIG. 1.

FIG. 5 shows a two layer plastic, according to some embodiments of the present invention.

FIG. 6 shows a light emitting diode (LED) according to some embodiments of the present invention.

### DESCRIPTION OF PREFERRED EMBODIMENTS

Some embodiments of the present invention will now be described by way of example only. It is to be understood that the examples may be combined and/or modified.

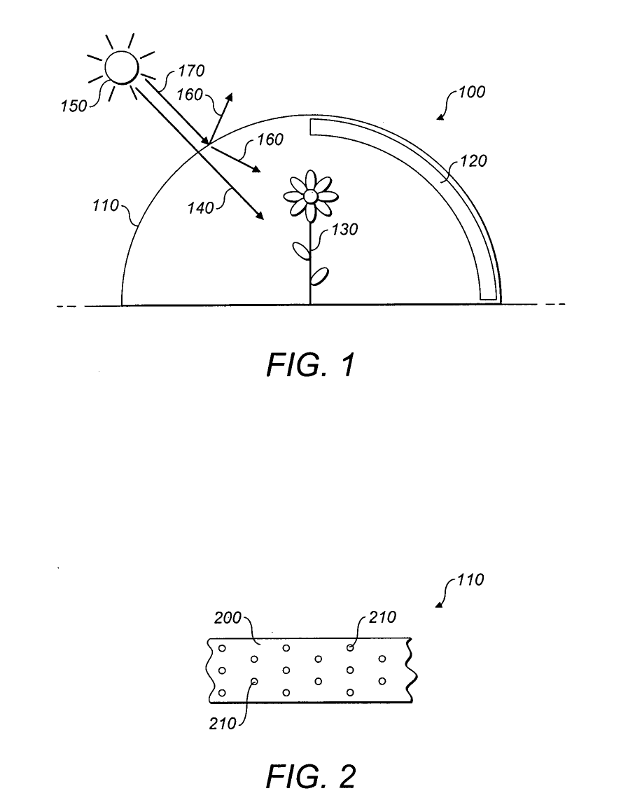

FIG. 1 shows a polytunnel 100 comprising a plastic sheet 110 stretched over “n” shaped hoops 120. Polytunnels are known for growing crops and in effect operate as greenhouses. For clarity, only one side of a hoop 120 is shown although the hoops 120 extend from one side of the polytunnel 100 to the other side. A plurality of hoops 120 form a frame that supports the plastic sheet 110. In this embodiment, the hoops 120 are formed of 50 mm tubular steel and are 2.8 m high and 5.3 m wide. The hoops 120 are spaced apart by 2.4 m so that the polytunnel 100 may be of substantially arbitrary length.

A plant 130 receives light 140 directly from the sun 150 and also receives light resulting from re-radiation 160 (at a down converted wavelength) of UV light 170 that would otherwise damage the plastic sheeting 110.

FIG. 2 shows a cross-sectional view of a portion of the plastic sheet 110. The plastic sheet 110 comprises plastic 200 and a phosphor 210. In this embodiment the plastic 200 is PVC (poly vinyl chloride) although it will be appreciated that other plastics such as polythene could be used. In this embodiment the phosphor 210 comprises particles of iron activated lithium aluminate phosphor, for example LiAlO₂:Fe and/or LiAl₅O₈:Fe.

Phosphors in other embodiments may be Ce(Mg,Mn)Al₁₁O₁₉:Cr or (Ba, Eu, Mn, Mg)Al₁₀O₁₇:Cr. Other examples of phosphors are aluminate lattices co-doped with one or two from Ce, Mn, Cr or a combination of all three. Yet other examples of phosphors are barium magnesium aluminate (BAM) lattices co-doped with one or two from Eu, Mn, Cr or a combination of all three. More generally, the phosphor may be based on families of lattices consisting of aluminates, silicates, aluminosilicates, phosphates or borates or mixtures thereof. Activators/co-activators/sensitizers from Fe, Cr, Ni, Mn, and other transition metals and Eu, Ce and other lanthanides, either singly doped or as a combination.

The particles 210 may be generally spherical or disc shaped and preferably have an effective diameter of the order of 1 μm, more preferably of the order of 100 nm, more preferably of the order of 10 nm.

Particles that are of a size comparable to the wavelength of light (the human eye is typically sensitive to light in the range 380 nm to 780 nm) will scatter light so nanometre scale particles are preferred as such particles will not scatter visible light to a significant extent.

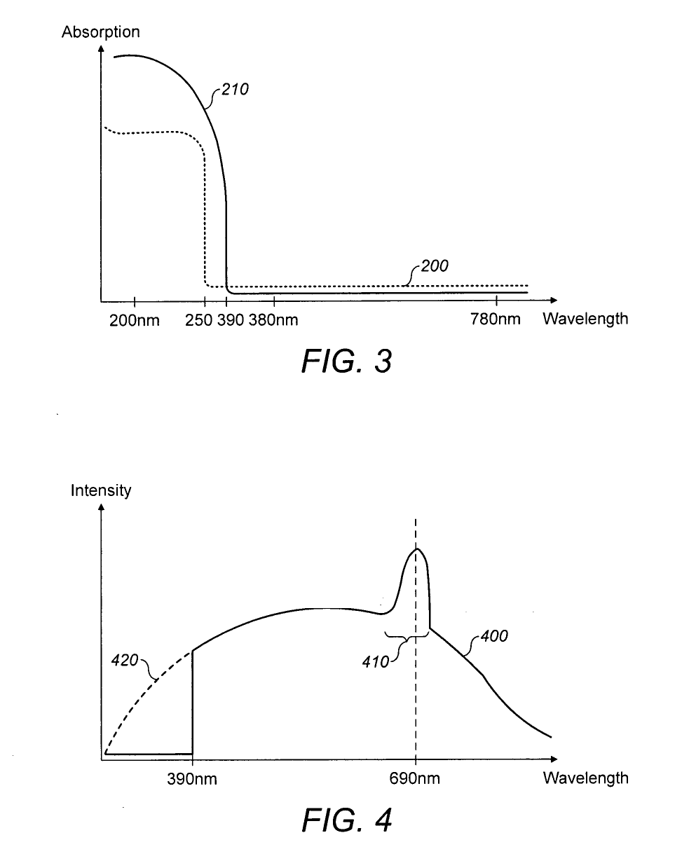

FIG. 3 shows a diagram of light absorption versus wavelength for the plastic 200. In this case, the PVC plastic 200 has a “knee” (in other words, a cut-off in the absorption spectrum) in its response curve, at about 250 nm. At wavelength longer than about 250 nm, the PVC is substantially transparent. At wavelengths below about 250 nm, the PVC plastic 200 absorbs UV light and would otherwise be damaged by the absorbed UV light.

FIG. 3 also shows the light absorption versus wavelength for the phosphor 210. In this embodiment, the phosphor 210 also has a “knee” in its response curve, at about 390 nm. Thus the phosphor 210 does not impede the passage of visible light through the plastic sheet 110 but the phosphor 210 will absorb light having a wavelength shorter than 390 nm, including light at a wavelength of less than 250 nm (which light would otherwise damage the PVC from which the plastic sheet 110 is made).

FIG. 4 shows the affect of the phosphor 210 on the resulting light spectrum 400 that is received by the plant 130. As can be seen, the curve 400 generally corresponds to the black-body radiation emitted by the sun 150. The plant 130 receives only a little light having a wavelength less than 390 nm. This is because such UV light has been absorbed by the phosphor 210 within the plastic sheet 110.

The phosphor 210 reradiates the UV light in a band 410 centred at 690 nm. Many plants comprises chlorophyll and mainly absorb light, for photosynthesis, at 680 nm and 700 nm (the exact wavelength can depend on the species of plant). Thus light 420 that would otherwise be of no use to the plant 130, and that could damage the plastic 200, has been down converted to a wavelength that promotes the growth of the plant 130.

In alternative embodiments, the phosphor 200 may be arranged to reradiate the UV light in two bands, one centred at 680 nm and the other centred at 700 nm. For example, a mixture of two phosphors may be used, one for reemission at 680 nm and the other for reemission at 700 nm. In yet other embodiments, the phosphor 200 may be sued to promote some other biological process. In some embodiments, instead of promoting the growth of plants, the growth of algae or cyanobacteria may be promoted. For example, bacteriochlorophyll absorbs light at 960 nm and thus in some embodiments the reradiated light may be at 960 nm instead of 690 nm.

Even when the plastic sheet 110 is being used to grow plants, it may be advantageous to reradiate some of the incident UV light in the infra-red band, for example at 960 nm. Such re-radiation can be used to provide additional (that is, additional compared to what would have been received straight form the sun 150) heating to the plant 130. Thus the plastic sheet 110 may comprise two phosphors: one to reradiate at about 690 nm, to promote photosynthesis of the plant 130, and another to reradiate at an infrared wavelength, to warm the plant 130 and thus promote faster growth of the plant 130.

In other embodiments, the phosphor 210 may be used to provide protection to structural members instead of the plastic sheet 110.

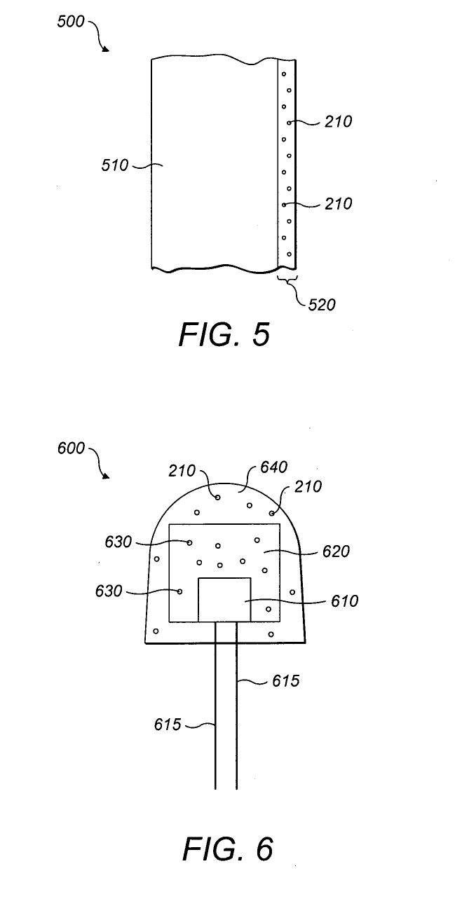

FIG. 5 shows a two layer plastic 500 comprising a first layer 510 that does not include any phosphor together with a second layer 520 that contains particles of phosphor 210. In this embodiment the plastic 500 may be used to make plastic glazing that may be used instead of conventional glass glazing. Plastic glazing has the advantage of being lighter and tougher than glass. Polycarbonate is a suitable plastic for one or both of the layers 510, 520 but conventional polycarbonate deteriorates on exposure to UV. The phosphor 210 in the second layer protects the polycarbonate in the layers 500, 510 from degradation. The second layer 520 may have a thickness of 0.5 μm while the first layer 510 may have a thickness of 6 mm.

Another application of the two layer plastic 500 is for biodegradable shopping bags. Some conventional biodegradable plastics are excessively vulnerable to UV-induced photo-degradation. Where the structure 500 is used to form shopping bags, the phosphor layer 520 is arranged on the outside of the shopping bag (not shown) so that the biodegradable inner layer 510 is protected from UV; such a structure may use a first polymer for the first layer 510 and a second polymer for the second layer 520. When it is desired to break down the shopping bag, the shopping bag may be cut into shreds and UV light allowed to hit the first layer 510. The first layer 510 will then break down leaving only the second layer 520. The second layer 520 may be arranged to form only a small proportion (e.g. 1 or 2%) of the mass of a shopping bag and thus the amount of residual waste will only be a small fraction of the original shopping bag. An advantage of some embodiments of the present invention is that the chemicals within the phosphor 210 are relatively benign and will not lead to contamination of landfills or drinking water supplies.

In yet other embodiments, a third layer (not shown) may be placed on the other side of the first layer 510, so that both the front and back faces of the first layer 510 are protected from UV.

In yet other embodiments, the first layer 510 may include phosphor 210, for example at a reduced concentration compared to the second layer 520.

As those skilled in the art will appreciate, when light is absorbed by a material having a given absorption coefficient (a), the majority of the energy is absorbed by the surface region of the material and relatively little light penetrates towards the interior of the material. Thus in further embodiments, the second layer 520 may, instead of being a single layer as shown at FIG. 5, be provided as two or more sub-layers. The outermost sub-layer may contain phosphor 210 at a higher concentration than an inner sub-layer. In some embodiments, the outermost sub-layer may contain a first phosphor and an inner sub-layer may comprise a second phosphor that absorbs and/or re-radiates at different wavelengths compared to the first phosphor. In other embodiments (not shown), a layer of phosphor 210 is applied by painting and/or spraying phosphor 210 onto a plastics substrate (not shown).

FIG. 6 shows a light source 600, in this embodiment based on a light emitting diode (LED) 610 having electrical connections 615. In this embodiment, the LED 610 emits UV light and is surrounded by a plastic 620 that contains a phosphor composition 630. In this embodiment, the phosphor composition 630 comprises a mixture of three different phosphors, one arranged to convert the UV light to red light and the others arranged to convert the UV light to blue and green light, respectively.

An encapsulant 640 contains phosphor 210 that converts UV light to infra-red light. One function of the encapsulant 640 is to absorb any UV light that has not been absorbed by the phosphors 630 and thus reduce unwanted UV radiation that would otherwise emanate from the light source 600. One use of the light source 600 is for interior lighting and in such applications the emission of UV light is generally undesirable.

Embodiments described above used phosphors 210 to protect the plastics. In other embodiments, some of the UV protection may come from the phosphors 210 and conventional UV protectors may provide additional protection.

Polytunnels 100 were described above as being supported by loops 120. In other embodiments, for example when growing strawberries, the plastic 110 may be extended across or along between furrows in a field. The word “greenhouse” is used in this description to refer to polytunnels, incubators having glazing panels and plastic as used for promoting the growth of strawberries, for example.

As those skilled in the art will appreciate, plastics/polymers are often supplied in the form of granules which are then processed to form, say, a sheet end product. Plastics according to the present invention may be supplied as granules. Plastics according to the present invention may comprise a mixture of two or more polymers.

In some embodiments, there are disclosed plastics materials (110; 520; 640) that include one or more phosphors (210) for absorbing ultraviolet (UV) light (170, 420) and re-radiating (160, 410) the light at a longer wavelength, for example the red wavelengths at 680 nm and 700 nm used by a plant (130) for photosynthesis. Such plastics materials may be used to protect the plastic (110, 500) from UV-induced degradation. In another embodiment, a light source (600) is provided with an encapsulant (640) that contains a phosphor (210) to prevent UV-light from escaping from the light source. Examples of the phosphor (210) are iron activated lithium aluminate phosphor although the phosphor may be based on lattices comprising, for example, aluminates, silicates, aluminosilicates, phosphates or borates or mixtures thereof. The phosphors may include activators/co-activators/sensitizers based on transition metals or lanthanides.

1-36. (canceled)

37. A method of reducing UV degradation of a polymer, the method including the step of providing a polymer with a phosphor, wherein the phosphor is configured to:
a. receive UV light incident on the polymer, and
b. re-radiate the received light at a longer wavelength.

38. The method of claim 37 wherein the phosphor is configured to re-radiate the light at a wavelength that promotes plant growth.

39. The method of claim 38 wherein the phosphor is configured to re-radiate the light to stimulate chlorophyll-based photosynthesis.

40. The method of claim 37 wherein the phosphor includes a mixture of two or more phosphors.

41. The method of claim 37 wherein the phosphor includes particles having an effective diameter smaller than a wavelength of visible light.

42. The method of claim 37 wherein:
a. the polymer has a polymer cut-off wavelength in its light absorption spectrum such that the polymer absorbs UV light having a wavelength shorter than the polymer cut-off wavelength,
b. the phosphor has a phosphor cut-off wavelength in its light absorption spectrum such that the phosphor absorbs light having a wavelength shorter than the phosphor cut-off wavelength, and
c. the phosphor cut-off wavelength is longer than the polymer cut-off wavelength.

43. The method of claim 42 wherein the phosphor cut-off wavelength is less than 100 nm away from the polymer cut-off wavelength.

44. The method of claim 37,
a. the polymer has a polymer cut-off wavelength in its light absorption spectrum such that the polymer absorbs UV light having a wavelength shorter than the polymer cut-off wavelength,
b. the phosphor has a phosphor cut-off wavelength in its light absorption spectrum such that the phosphor absorbs light having a wavelength shorter than the phosphor cut-off wavelength, and
c. the phosphor cut-off wavelength is at least substantially equal to the polymer cut-off wavelength.

45. The method of claim 37:
a. wherein the polymer with the phosphor forms a first layer,
b. further including the step of providing a second layer of polymer adjacent the first layer.

46. The method of claim 45 wherein the second layer of polymer also includes a phosphor configured to:
a. receive UV light, and
b. re-radiate the received light at a longer wavelength.

47. The method of claim 46 wherein the composition of the phosphor of the first layer is different from the composition of the phosphor of the second layer.

48. The method of claim 46, wherein the concentration of the phosphor of the first layer is different from the concentration of the phosphor of the second layer.

49. The method of claim 37, wherein the polymer includes a UV-absorbing compound other than a phosphor.

50. The method of claim 37 further including the step of fabricating a greenhouse using the polymer with the phosphor.

51. The method of claim 50 wherein the greenhouse includes glazing, the glazing being at least partially formed of the polymer with the phosphor.

52. The method of claim 50 wherein the polymer with the phosphor is in the form of a sheet.

53. A composite including a polymer and a phosphor wherein the phosphor is configured to:
a. receive UV light incident on the polymer, and
b. re-radiate the received light at a longer wavelength.

54. The composite of claim 53 wherein the phosphor is configured to re-radiate the light at a wavelength that promotes plant growth.

55. The composite of claim 53 wherein:
a. the polymer has a polymer cut-off wavelength in its light absorption spectrum such that the polymer absorbs UV light having a wavelength shorter than the polymer cut-off wavelength,
b. the phosphor has a phosphor cut-off wavelength in its light absorption spectrum such that the phosphor absorbs light having a wavelength shorter than the phosphor cut-off wavelength, and
c. the phosphor cut-off wavelength is at least substantially equal to the polymer cut-off wavelength.

56. The composite of claim 53 in combination with a greenhouse, wherein the composite defines at least a portion of the greenhouse.
